(19) United States
(12) Patent Application Publication
(10) Pub. No.: US 2001/0034689 A1
(43) Pub. Date: Oct. 25, 2001

(54) Method and system of negotiating a transaction over a network

(76) Inventor: Theodore A. Heilman JR., New York, NY (US)

Correspondence Address: George T. Marcou, Esq., Kilpatrick Stockton LLP, Suite 800, 700 13th Street, N.W., Washington, DC, 20005, US

(21) Appl. No.: 09/766,419

(22) Filed: Jan. 19, 2001

Related U.S. Application Data
(60) Provisional application No. 60/177,400, filed on Jan. 21, 2000.

(51) Int. Cl. G06F 17/60; H04K 1/00; H04L 9/00

(52) U.S. Cl. 705/37; 705/80

(57) ABSTRACT

A method and system for negotiating a transaction over a network makes use of computer hardware and software to enable buyers, sellers and brokers of goods and/or services to communicate and trade with one another over the Internet. A first user logs on the system and places a quote to buy or sell a product or service on the web site, and a second user can access and choose to respond to the quote. If the first user is not logged onto the system at the time, the system sends the first user a notice that someone has responded to the first user's quote. However, if the first user is logged onto the system, the system automatically displays a message inviting the first user to engage in an on-line “chat” session with the second user while reviewing contract terms in an amendable ticket containing the terms of the original quote. If the first user accepts, the first user is taken directly to a live negotiation ticket containing the terms of the first user's original quote. The negotiation ticket also has a live chat box imbedded in the ticket at the bottom of the screen which allows the first and second users to negotiate contract terms in the chat box while simultaneously passing amended versions of the negotiation ticket back and forth until a contract is concluded. The system also enables counterparty control on a quote-by-quote basis, as well as third party visibility control.

### PRIORITY APPLICATION

This application claims the benefit of U.S. Provisional Application No. 60/177,400 filed Jan. 21, 2000 entitled “Method and System of Negotiating a Transaction Over a Network,” incorporated herein by this reference.

### FIELD OF THE INVENTION

The present invention relates to the field of electronic commerce and more particularly to a method and system for negotiating a transaction over a network, such as the Internet.

### BACKGROUND

Currently, negotiating a transaction, such as the business of trading commodities and bulk products in general for physical delivery, is mostly done over the telephone. People come in, for example, in the morning and call up a number of contacts in their particular business. They attempt to find out what type of price is being bid, offered or has been traded for a given product or service. The people that deal in these products or services can be scattered all over the world. Obviously, in the course of a morning, it is possible to contact only so many of these people to find out what they have heard regarding the price of a given product or service. It is a slow, cumbersome and relatively inefficient system, which does not yield the best possible price.

### SUMMARY OF THE INVENTION

It is a feature and advantage of the present invention to provide a method and system that enables negotiating a transaction, such as a commodities trade, over a network such as the Internet, for either “spot” (immediate) or “forward” (future) delivery.

It is another feature and advantage of the present invention to provide a method and system for negotiating a transaction and communicating over the network to particular markets to people who buy and sell and broker the particular products or services.

It is a further feature and advantage of the present invention to provide a method and system for negotiating a transaction that enables buyers, sellers and brokers of products or services to trade and conduct business with one another over the network.

It is an additional feature and advantage of the present invention to provide a method and system for negotiating a transaction, such as trading commodities or other products traded in bulk, that enables counterparty control on a quote-by-quote basis.

It is a still further feature and advantage of the present invention to provide a method and system for negotiating a transaction, such as trading commodities or other products traded in bulk, that allows third party visibility control (“posting levels”).

It is still another feature and advantage of the present invention to provide a method and system for negotiating a transaction, such as trading commodities, that replaces expensive and time consuming telephonic and/or fax communications between counterparties with a far more efficient manner of initiating and conducting negotiations electronically over the network.

It is still another feature and advantage of the present invention to provide a method and system for negotiating a transaction that enables trading of any type of product or service, including without limitation, commodities, over the network.

To achieve the stated and other features, advantages and objects of the present invention, an embodiment of the present invention makes use of computer hardware and software to enable users, such as buyers, sellers and brokers of goods and/or services of all types, to communicate and trade with one another over a global network, such as the Internet. In an embodiment of the present invention, a first user, such as a seller, logs on the system and places a quote to buy or sell a product or service on the web site. Another user seeing the quote and having an interest in it can access the quote and choose to respond. If the first user is not logged onto the system at the time, the system simply sends the first user a message informing the first user that someone has responded to the first user's quote.

However, if the first user is logged onto the system, the system automatically offers an option to display a message on the first user's screen inviting the first user to engage in an on-line “chat” session with the second user while reviewing contract terms in an amendable ticket containing the terms of the original quote. The first user can accept the invitation to negotiate, in which case, the first user is taken directly to a live negotiation ticket containing the terms of the first user's original quote that also has a live chat box embedded into it at the bottom of the screen. This chat box/ticket screen allows the first and second users to haggle over contract terms in the chat box while simultaneously passing amended versions of the negotiation ticket back and forth.

An embodiment of the present invention provides a method and system for negotiating a transaction over a network, such as the Internet, in which the first user is allowed to enter information relative to a quote for a proposed transaction into the system at a first user terminal, such as the first user's personal computer (PC), coupled to a system web site server over the network. The first user enters the information relative to the quote, for example, on either a blank negotiation ticket or a pre-formatted negotiation ticket on a quote entry area displayed for the first user on a display screen of the first user terminal.

The information relative to the quote includes, for example, one or more of a subject matter description for the proposed transaction, a quantity for the proposed transaction, a payment term for the proposed transaction, a delivery term for the proposed transaction, and a price term for the proposed transaction. After entering the information, the first user can specify, for example, whether the information relative to the quote is for a firm quote, which can be accepted by a pre-approved counterparty, or an inquiry quote, which only demonstrates the first user's interest in the proposed transaction.

A second user can access the entered information relative to the quote at a second user terminal, such as the second user's PC, likewise coupled to the system web server over the network according to pre-defined parameters established by the first user. The parameters include, for example, being one of a list of counterparties pre-approved by the first user for that particular transaction and a level of permitted visibility to counterparties not pre-approved for that transaction of the information relative to the quote. The second user can pull up a display of a summary of the information relative to the quote in a quote summary area of a quote board on the display screen of the second user's terminal. Subject to these parameters, the second user can also pull up details of the information in a quote recap area of the quote board.

If the second user wishes to respond to the quote, the second user can enter information relative to a response to the quote for the proposed transaction at the second user terminal. For this purpose, the second user is allowed to enter the information on an amendable negotiation ticket filled out with the information relative to the quote, which is displayed on the display screen of the second user terminal. The amendable negotiation ticket is displayed for the second user in response to a selection by the second user of a respond option on a quote recap window on the display screen of the second user terminal. The second user can enter one or more amendments to the filled out information on the amendable negotiation ticket and can designate the information relative to the response as either a firm response, which becomes a firm quote negotiable only by the user to which the response is made, or an inquiry response, which becomes an inquiry quote negotiable only by the user to which the response is made.

The information relative to the response is presented to the first user at the first user terminal according to a selection for a preferred presentation method of the second user. At the second user's option, the information can be presented on a response page for the first user with an email notification of the information also sent to the first user. Alternatively, at the second user's option, the information can be presented in connection with an invitation to the first user for a live, online negotiation In the latter case, if the first user is unavailable online, the second user is automatically notified and offered an option of presenting the information on a response page for the first user with an email notification sent to the first user or the first user can cancel the response. However, in the latter case, if the first user is available online, the first user is presented an amendable negotiation ticket on which the second user was allowed to enter one or more amendments designated as either a firm response or an inquiry response.

The system for an embodiment of the present invention prompts the first user at the first user terminal to view the information relative to the response. If the first user declines an invitation from the second user for a live online negotiation with the second user, the system sends a notification to the second user that the invitation was declined, sends a confirmation to the first user that the invitation was declined, and also sends a notification to the second user that the information relative to the response will appear on a response page of the first user. When the second user accesses the information relative to the quote, if the first user is available online, the system sends a notice to the first user that the information has been accessed.

When the second user selects the option for an invitation to a live negotiation, if the first user is available online, the system for an embodiment of the present invention queries the first user regarding the first user's willingness to negotiate directly online with the second user. The system queries the first user, for example, by displaying a message for the first user inviting the first user to engage in an on-line chat session with the second user while reviewing an amendable negotiation ticket. If the first party accepts the invitation, the system displays the amendable ticket for the first user, which consists of a modifiable and electronically transmittable negotiation ticket integrated with an internet relay chat box enabling the first and second users to communicate and pass the ticket back and forth.

If, during the course of communicating with one another by passing the modifiable and electronically transmittable negotiation ticket integrated with the internet relay chat box back and forth, a firm offer is made and accepted by one or the other of the first and second users, and an agreement relative to the proposed transaction is reached, the system for an embodiment of the present invention confirms a contract between the first and second users relative to the proposed transaction. The system assigns a transaction number to the confirmed contract and sends a notice of the confirmation to each of the first and second users. In addition, either of the first and second users can print out a hard copy of the confirmed contract.

Additional objects, advantages and novel features of the present invention will be set forth in part in the description which follows, and in part will become more apparent to those skilled in the art upon examination of the following or may be learned by practice of the invention.

### BRIEF DESCRIPTION OF THE DRAWINGS

FIG. 1 FIG. 1 is a schematic diagram, which illustrates an example of key components and the flow of information between key components of the system for an embodiment of the present invention;

FIG. 2 shows a sample Quote Board GUI screen visible in the form of Quote Summaries for an embodiment of the present invention;

FIG. 3 shows an example of the Quote Recap GUI window for an embodiment of the present invention;

FIG. 4 shows a sample Negotiation Screen for an embodiment of the present invention;

FIG. 5 shows a sample Negotiation History GUI screen for an embodiment of the present invention;

FIG. 6 shows a sample My Physicals area with an Active Quotes GUI page visible for an embodiment of the present invention;

FIG. 7 shows a sample My Physicals area with a bottom part of the Active Quotes page visible for an embodiment of the present invention;

FIG. 8 shows a sample Create New Quote GUI page of the My Physicals area for an embodiment of the present invention;

FIG. 9 shows an example of the principal or Home page of registered users of the system for an embodiment of the present invention;

FIG. 10 shows an example of a lower part of the Market Summary GUI page for an embodiment of the present invention;

FIG. 11 shows an example of a bottom part of the Market Summary GUI page for an embodiment of the present invention;

FIG. 12 shows another example of the Recent Quotes Board for an embodiment of the present invention;

FIG. 13 is a table which illustrates examples of various combinations of quotes and responses that can arise during negotiations in the system and method for an embodiment of the present invention;

FIG. 14 is a schematic flow chart which illustrates and example of the process of responding to a quote according to the system and method for an embodiment of the present invention;

FIGS. 15, 16 and 17 show a sample Quote Review GUI page for an embodiment of the present invention as it appears in submitting an original quote;

FIG. 18 is a schematic flow chart which illustrates an example of the process of Posting Level selection for an embodiment of the present invention;

FIGS. 19 and 20 show a sample GUI screen for selection of a firm's Firm Master Counterparty List for an embodiment of the present invention;

FIG. 21 shows a sample Main Managing Personal Counterparty Lists GUI page for an embodiment of the present invention; and

FIG. 22 shows a sample Add (Create) New Personal Counterparty List page for an embodiment of the present invention.

### DETAILED DESCRIPTION

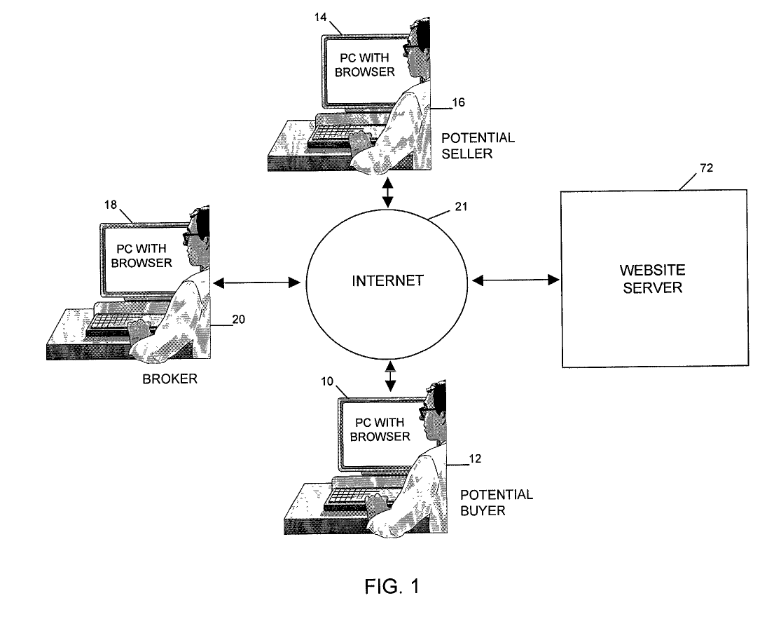

Referring now in detail to an embodiment of the present invention, an example of which is illustrated in the accompanying drawings, FIG. 1 is a schematic diagram, which illustrates an example of key components and the flow of information between key components of the system for an embodiment of the present invention. The system and method for an embodiment of the present invention provides trading information and communication services over the Internet 21 to markets for all types of goods and/or services, including without limitation commodities markets, to people who buy and sell and broker the particular goods and/or services. Such commodities markets can include, for example, raw coffee, metals, sugar, bulk fertilizer, and industrial raw material inputs, to name a few. However, the system enables negotiating transactions involving all types of goods/services and makes use of software to enable buyers, such as potential buyer 10 at his or her terminal 12, sellers, such as potential seller 14 at his or her terminal 16, and brokers, such as broker 18 at his or her terminal 20, of all kinds of products and/or services to trade with each other over the Internet and to conduct business over the Internet 21. Other features include, for example, industry news, chat functions, e-mail functions, as well as the trading functionality.

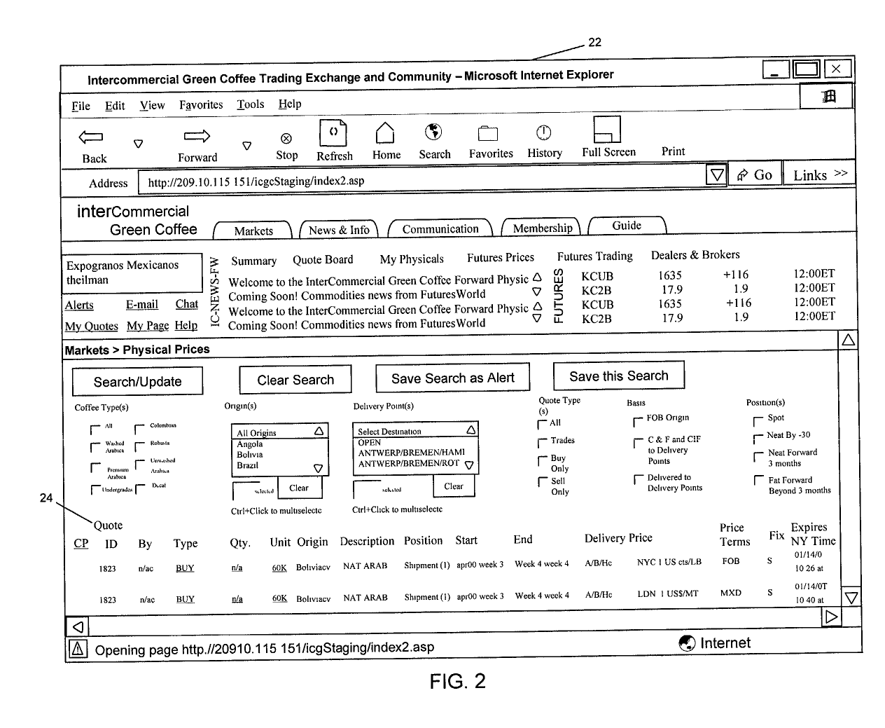

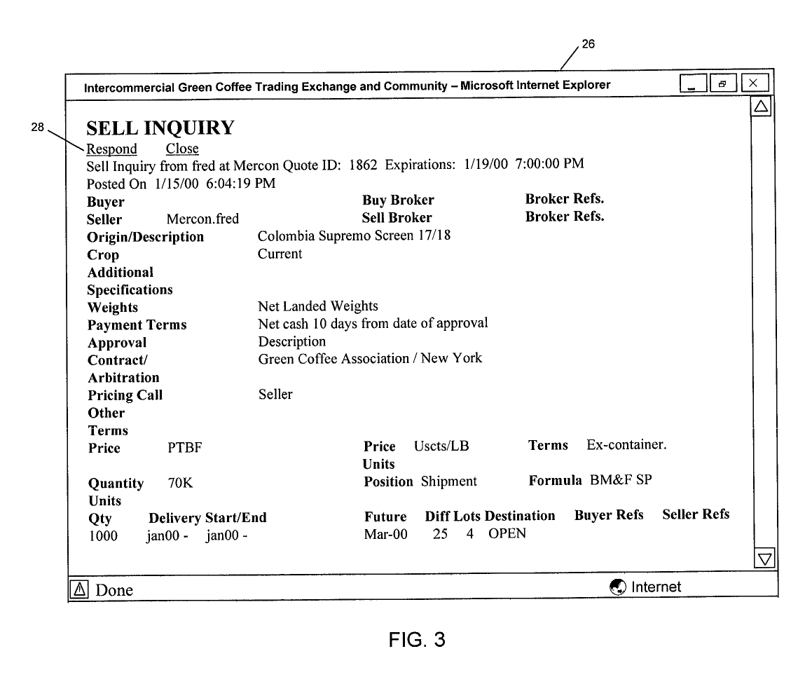

Principal trading features of the system and method for an embodiment of the present invention include, for example, a News Frame, a Market Summary page, a Recent Quotes and Trades Board, a Quote Board, Quote Summaries, a Quote Recap, a Negotiation Screen, a Negotiation History, a My Physicals area, an Active Quotes page, and a My Trades and Postings area. FIG. 2 shows a sample Quote Board GUI screen 22 visible in the form of Quote Summaries 24 for an embodiment of the present invention. The Quote Board 22 is employed for searching for and viewing quotes posted by others on the system and contains the Quote Summaries 24. Details of a quote are obtained by clicking on underlined links in the Quote Summaries 24. Upon clicking on a link, a window pops up containing a Quote Recap with full details of the quote. FIG. 3 shows an example of the Quote Recap GUI window 26 for an embodiment of the present invention. The Quote Recap window 26 contains full details of a quote that pops up when a user clicks the link on the Quote Summary 24 as shown in FIG. 2. From the Quote Recap window 26, a user can choose to respond to a quote by clicking on a Respond link 28 and is then taken to a Negotiation Screen, which also contains all the details of the quote albeit in the form of a ticket with modifiable terms.

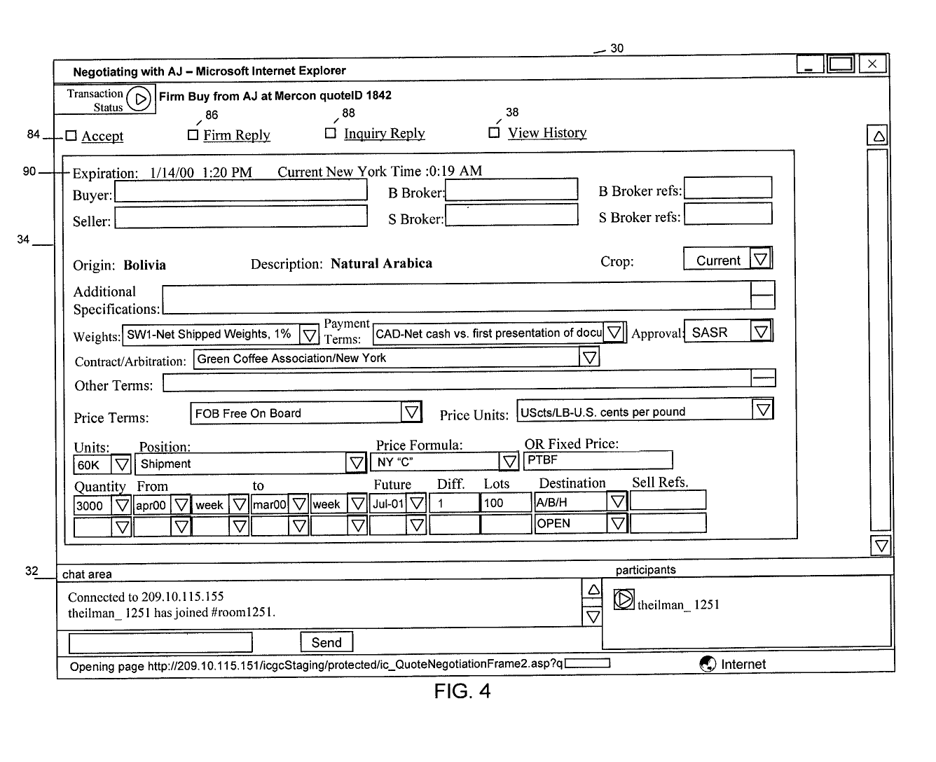

FIG. 4 shows a sample Negotiation Screen 30 for an embodiment of the present invention. If the party that originally posted the quote is online, the responding user has the option of engaging that party in online negotiation and “chat.” If the party that originally posted the quote is not online or the responding user does not wish to negotiate live online, the responding user may reply offline, and an e-mail message with the response is sent by the system to the party that posted the quote. A response may be a counterproposal with terms different from the original quote, or it may be an acceptance of the original terms, in which case a transaction is completed and shows up on system Quote Boards 22 (FIG. 2) as a completed trade. Referring further to FIG. 4, the Negotiation Screen 30 has an integrated two-way Chat box 32 at the bottom and a Negotiating Ticket 34 with fields having drop-down multiple-choice lists or fill-in boxes that enable the user to alter terms and respond to the user's online negotiation counterparty. During a live negotiation, the negotiating counterparty receives altered tickets with changed fields highlighted in yellow. Such a chat goes on uninterrupted in the Chat box area 32 as Negotiating Tickets 34 with varying terms and prices are passed back and forth between the two negotiating parties.

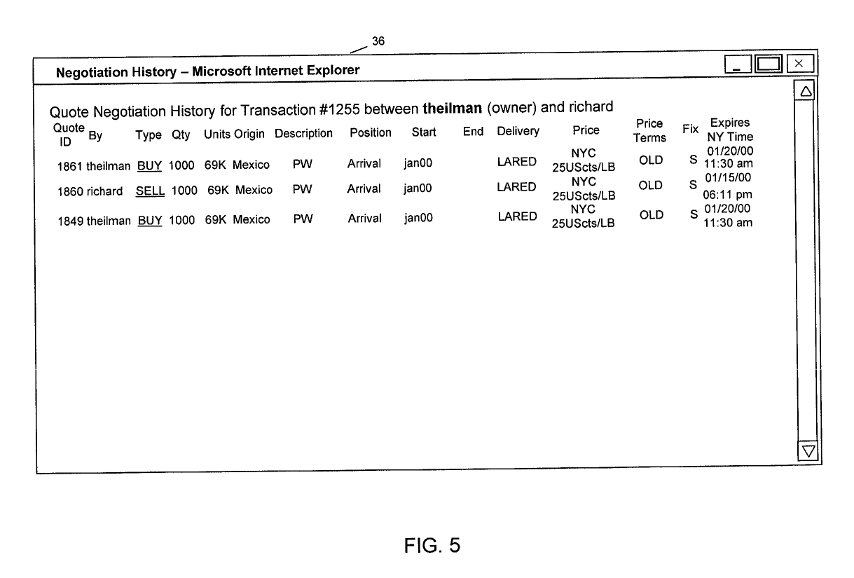

A Negotiation History provides a detailed history of the back and forth of a negotiation. FIG. 5 shows a sample Negotiation History GUI screen 36 for an embodiment of the present invention. At any point in the negotiations, either party can click on a View History link 38 on the Negotiation Screen 30, as shown in FIG. 4, and review the various versions of terms traded back and forth. Details of a particular round can be obtained by clicking on underlined links, which pops up a window with a full recap of the terms of that negotiation round.

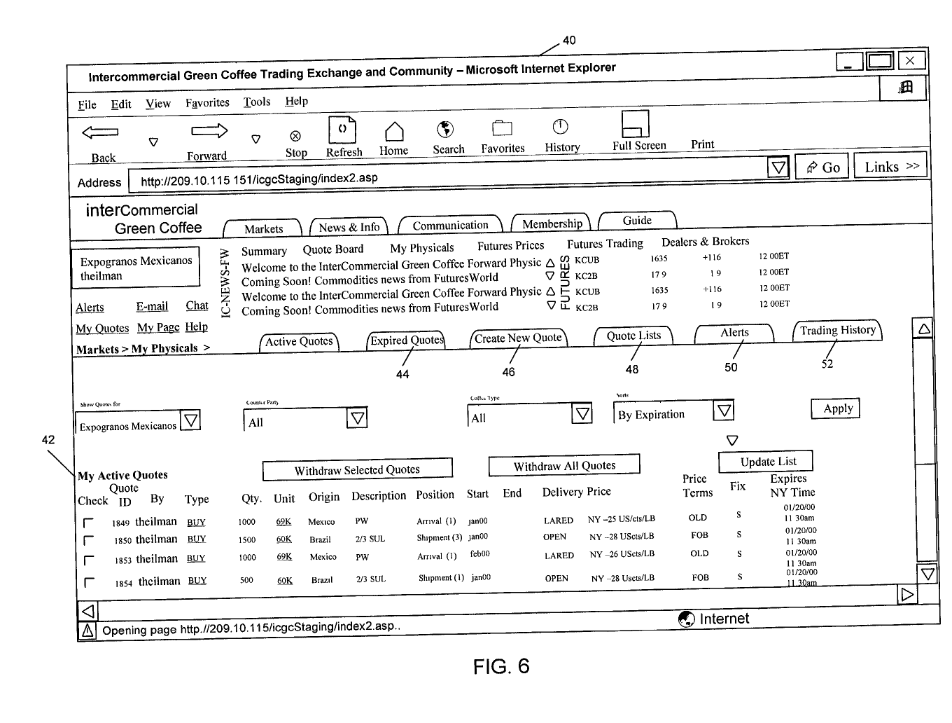

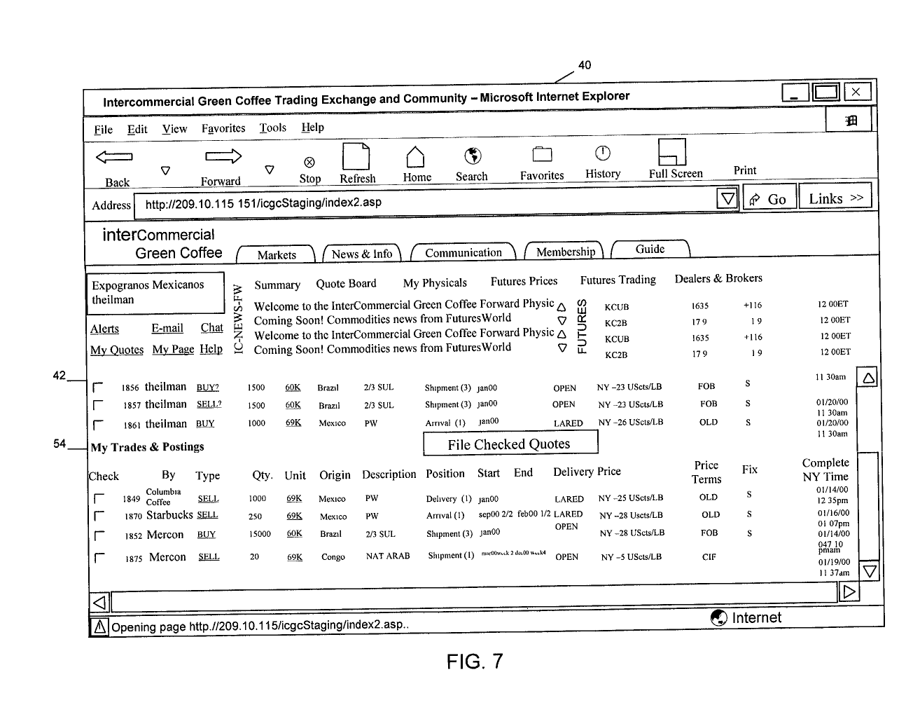

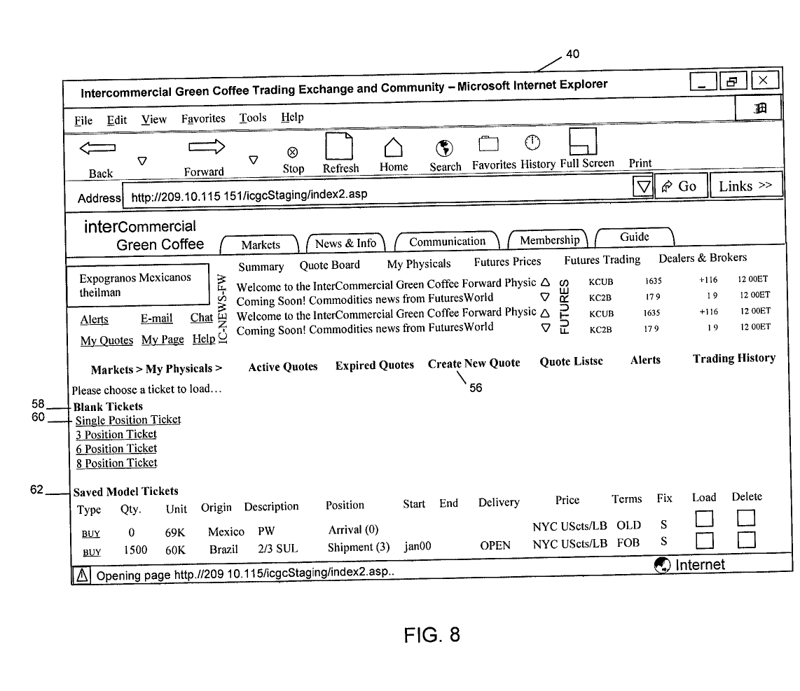

FIG. 6 shows a sample My Physicals area with an Active Quotes GUI page visible for an embodiment of the present invention. Referring to FIG. 6, the top of the user's My Physicals area 40, with the Active Quotes page 42 visible, indicates to the user all of the unexpired quotes that the user has working on the system. From the My Physicals area 40, the user can also access pages with the user's recently Expired Quotes 44, Create New Quotes 46, manage quotes in groups known as Quote Lists 48, set Alerts 50 so the system will notify the user when certain types of quotes are posted by others to the system, and see the user's Trading History 52 detailing the user's completed transactions. FIG. 7 shows a sample My Physicals area 40 with a bottom part of the Active Quotes page 42 visible for an embodiment of the present invention. Referring to FIG. 7, at the bottom of the Active Quotes page 42 is the My Trades and Postings area 54, where a user can see the user's recently completed trades. FIG. 8 shows a sample Create New Quote GUI page 56 of the My Physicals area 40 for an embodiment of the present invention. From the Create New Quote page 56, a user creates new quotes for posting on the system for response by other users. New quotes can be created by starting from a Blank Ticket 58, from a list of Standard Tickets 60 or from Model Tickets 62 previously created by the user.

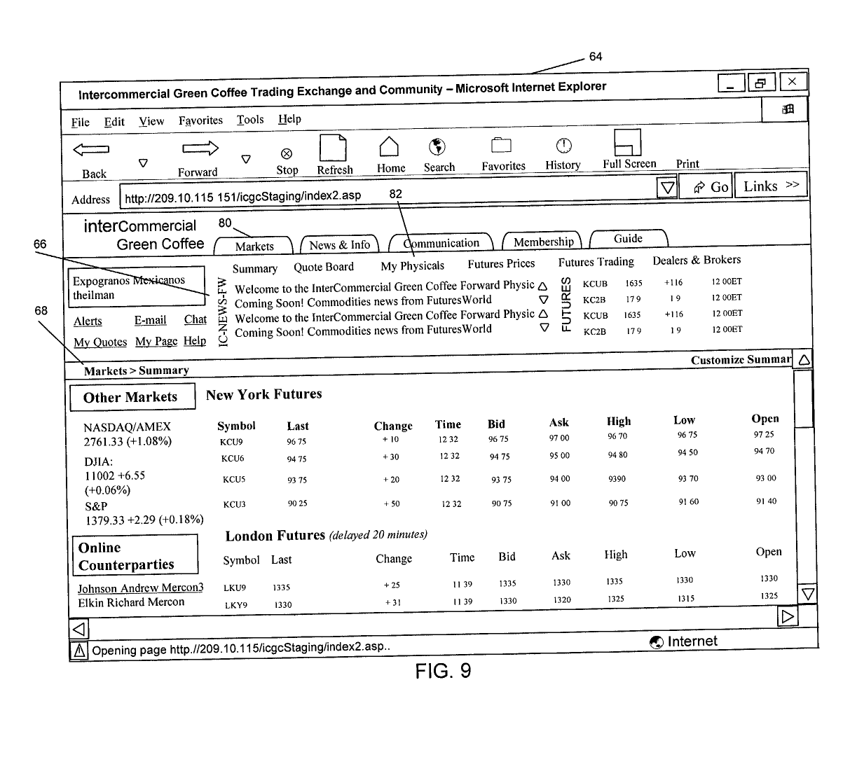

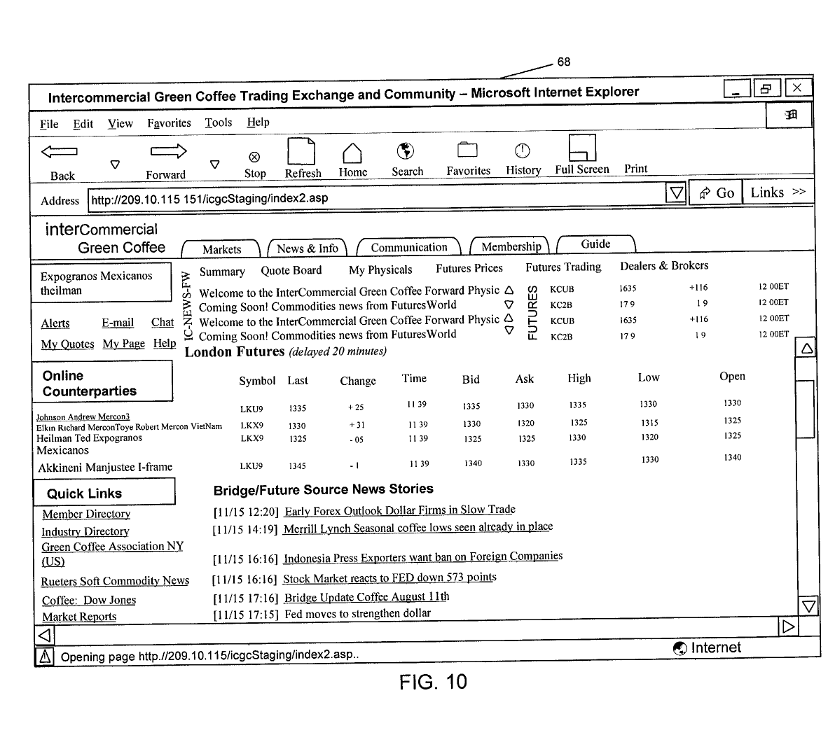

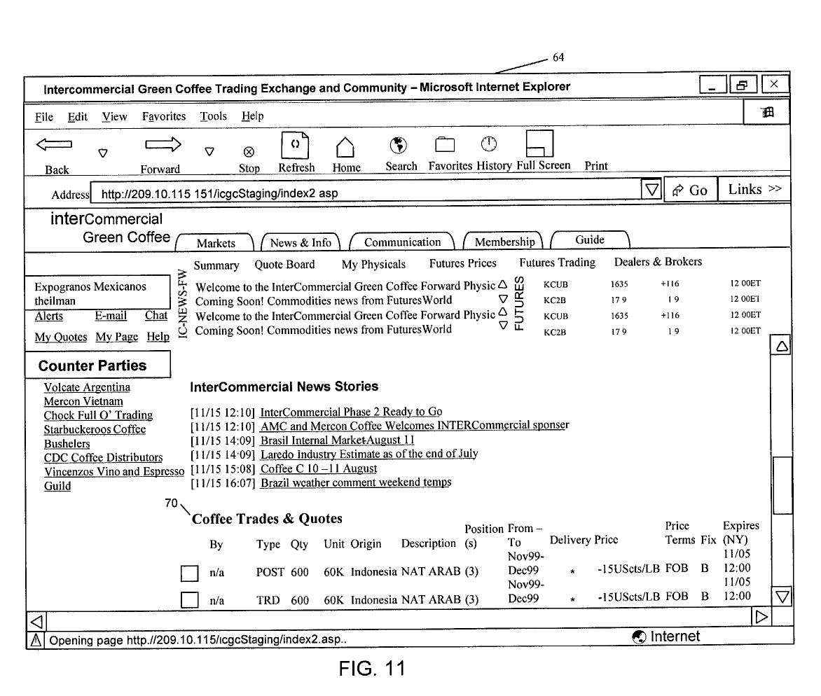

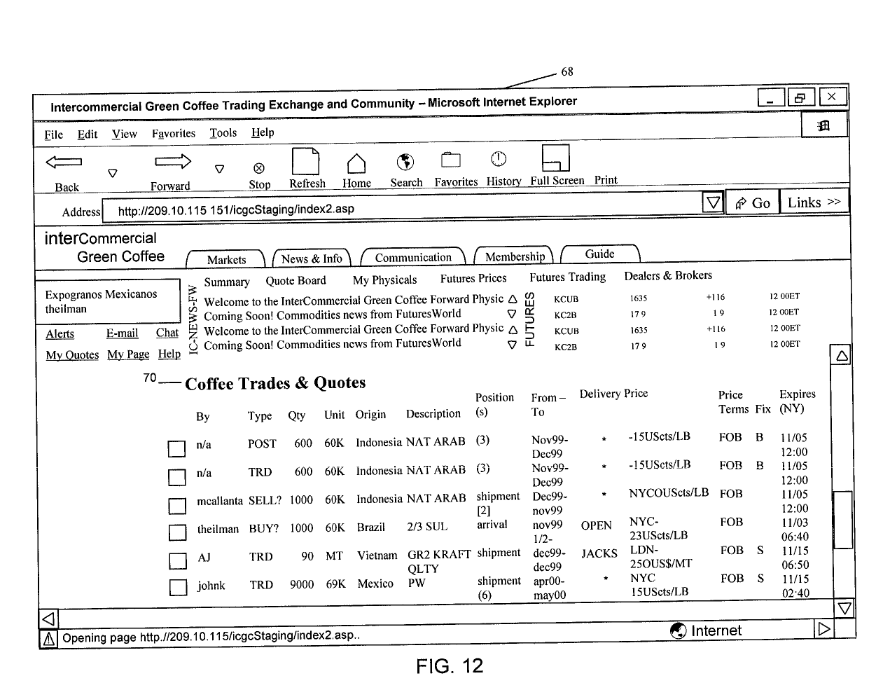

FIG. 9 shows an example of the principal or Home page 64 of registered users of the system for an embodiment of the present invention. At the top of the Home page 64 is a News Frame 66, which appears above all pages to keep the user informed of market news and information on a push basis, while the user navigates the other areas of the site. Below the News Frame 66, the top of a Market Summary page 68 is visible. The Market Summary page 68 is a user-customizable page that summarizes various types of information, including, news, market prices, and lists of other users currently logged on the system for an embodiment of the present invention and available for chat. FIG. 10 shows an example of a lower part of the Market Summary GUI page 68 for an embodiment of the present invention. FIG. 11 shows an example of a bottom part of the Market Summary GUI page 68 for an embodiment of the present invention. Referring to FIG. 11, the bottom part of the Market Summary page 68 includes a Recent Quotes Board 70 from which the user can enter into negotiation with the parties that posted the listed quotes. FIG. 12 shows another example of the Recent Quotes Board 70 for an embodiment of the present invention.

The system and method for an embodiment of the present invention makes use, for example, of Negotiating Tickets 34 and Quote Boards 22 on a web site running on a cluster of computers 72, such as Intel based computers, as shown in FIG. 1. The basic operating systems are, for example, Microsoft software, such as Microsoft NT and/or Microsoft IIS. The system includes proprietary software that records the transactions and posts them on Quote Boards 22, and then other people can come in and click on the quotes in order to pull up the information. An important feature of the system is the Negotiating Ticket 34. The system enables a potential buyer 10 to go into the web site 72 and see where others who deal, for example, in a particular product are offering the product, what they are bidding for the product, and where completed transactions in the product have recently been made.

As already mentioned, an important feature of the system and method for an embodiment of the present invention is the Negotiating or Trading Ticket 34, which enables a user, such as potential buyer 10, to see that a particular product, such as a parcel of raw coffee, is offered. The potential buyer 10 clicks on the Summary Information 24 for the offer and is able to pull up details of the offer. If it is of interest to the potential buyer 10, he or she can press a Respond button 28. This brings up a filled out Negotiating Ticket 34 which describes who the potential buyer 10 is, the exact description of the product, what the payment terms are, what the delivery terms are, and the like. At the same time, if the person who put the quote on the system is logged onto the system anywhere else on the Internet 21, the system detects that and automatically sends a message to that person informing him or her that his or her quote has been hit and asking whether he or she would like to negotiate directly over the Internet 21 with the potential buyer 10.

In an embodiment of the present invention, an option for the person who sees the quote on the Quote Board 22 is simply to accept it on the spot, and the deal is done. Typically, however, either the price or the terms are not quite what the person is looking for. For that purpose, the potential buyer 10 can click on the Respond button 28, and the system attempts to put the potential buyer 10 in direct on-line chat communication with the person who put the quote on the system. In that case, what appears is a Negotiation Screen 30 consisting of a modifiable and electronically transmittable Negotiating Ticket 34 integrated with an Internet relay Chat box 32, which enables the two parties to communicate using the keyboard and to pass the Negotiating Ticket 34 back and forth to each other. In other words, the potential buyer 10 pulls up the Negotiating Ticket 34 and says, for example, “I like the terms, but the price is a little high.” The other person can respond with, for example, “Well, I could come down a little bit; perhaps you can make me a firm counteroffer.” Either party can change the terms on the Negotiating Ticket 34 and, in effect, pass the Negotiating Ticket 34 over to the other side, where the other party can see the new terms and can continue to chat at the bottom of the screen. Alternatively, the chat can be conducted via voice over an Internet Protocol (IP) connection.

The method and system for an embodiment of the present invention provides a far more efficient way of initiating negotiations and, once they are initiated, a far more efficient way of conducting negotiations over the Internet 21. Thus, an embodiment of the present invention provides savings in time and avoids long distance telephone charges and the necessity of sending fax confirmations. Further, the system for an embodiment of the present invention is not confined to commodities, such as coffee, but can be used in trading any products or services, as well as all types of commodities. Simply by changing the product description, it is possible to trade any type of goods and/or services, and conceivably it is possible to trade, for example, Furby dolls. A unique feature of the system is the fact that all of the trading information is disposed on the Negotiating Ticket 34 which can be passed back and forth between the parties, and at the bottom of the particular screen is a Chat box 32 which can be used to pass comments and negotiation points back and forth between the parties.

In order to trade goods or services, including, for example, a commodity, such as coffee, via the system and method for an embodiment of the present invention, a potential buyer 10 logs in to the Home page 64 as shown in FIG. 9 with a user name and password. The potential buyer 10 then clicks on a Markets tab 80, and a menu pops up from which the potential buyer 10 selects and clicks on Physical Market 82. From there, the potential buyer 10 can go, for example, to the Quote Board 22 shown in FIG. 2, which pulls up various transactions that other people have put on the system. The potential buyer 10 can respond to one of the quotes and can see what the Negotiating Ticket 34 shown in FIG. 4 pulls up. In order to utilize the chat functionality, the person who put the quote on the system must be on the system.

For an example of a transaction using the system and method for an embodiment of the present invention, assume a seller, such as potential seller 14, of raw or green coffee for delivery at some point in the future is interested in offering it for sale. The potential seller 14, who is a registered member of the system, uses his or her PC 16 with a connection to the Internet 21 to log into the system web site 72 with his or her password. The seller 14 then goes into the Quote Entry area 40 shown in FIG. 8 and selects a Blank Ticket 58 or Pre-Formatted Ticket 60 or 62. The seller 14 fills out the details of the business which the seller 14 is interested in transacting, such as the exact quantity of the product, the exact description of the product, payment terms, delivery terms, and the like, as well as a price. The seller 14 can then submit it as a firm offer that can be instantly accepted by one of a number of counterparties that the seller 14 has pre-approved as acceptable to the seller 14. Alternatively, the seller 14 can enter it on the system as a selling inquiry, demonstrating some selling interest without enabling another party to simply automatically close the business on the spot. The seller 14 clicks on a Submit button, and the system then puts the sell quote on the various Quote Boards 22 in the web site 72. The persons who are allowed to see the particular quote depend on the various parameters set by the seller 14 that submitted the sell quote.

Continuing with the foregoing transaction example, assume that the seller 14 does not log off, but remains on the web site 72, for example, to see the other information on the web site 72, such as futures prices, news headlines, statistics, or the like. Assume also, for example, that a period of time, such as twenty minutes, passes while the seller 14 remains on the web site 72 and that during that time, somewhere else in the world, someone who buys coffee, such as potential buyer 10, enters a registered number of the system and logs onto the web site 72. The potential buyer 10 pulls up a Quote Board 22, as shown in FIG. 2, to see what sorts of things are being offered, including, for example, the selling offer that was put on twenty minutes earlier by the seller 14. The potential buyer 10 can pull up the details of the selling offer. If the seller 14 is someone with whom the potential buyer 10 is willing to do business, and all the terms, conditions and prices are exactly as the potential buyer 10 would like, the potential buyer 10 can accept the seller's firm offer on the spot. A message is then sent to the seller 14 that the seller's firm offer was accepted.

Still continuing with the transaction example, assume however that the potential buyer 10 likes most of the terms and conditions, but does not agree with certain of the terms. For example, after the potential buyer 10 logs on, the potential buyer 10 sees the Quote Summaries 24 on the Quote Board 22, as shown on FIG. 2, and pulls up the details on the Quote Recap 26 as shown in FIG. 3. The offer looks interesting, but the potential buyer 10 wants different price and delivery terms and decides to respond. The potential buyer 10 clicks on the Respond button 28, and the full Negotiating Ticket 34, as shown on FIG. 4, as originally filled out by the seller 14 is displayed for the potential buyer 10. At the same time, a message pops up which says, for example, “Xxxxxx (seller 14), who placed this quote, is on the system; would you like to initiate negotiations?” If the potential buyer 10 clicks Yes, the system sends a message to the seller 14 that placed the original quote on the system.

Continuing still further with the same transaction example, assuming that the seller 14 is still on the system, the seller 14 receives a message saying, for example, “Yyyyyy (potential buyer 10) has responded to your offer; would you like to negotiate?” If the seller 14 clicks Yes, at that point, both parties have an identical Negotiating Ticket 34, as shown in FIG. 4, before them showing one party as the buyer 10 and the other party as the seller 14, with all of the original terms and conditions filled in. In addition, there is a Chat box 32 at the bottom of the Negotiating Ticket 34 which puts the two parties in direct communication with one another. The two parties can then communicate through the Chat box 32 and negotiate terms and conditions and can also simultaneously or alternatively go into the Negotiating Ticket 34 and change the terms and, in effect, send the Negotiating Ticket 34 back and forth between them.

In the same transaction example, assume that the potential buyer 10 changes the price and delivery conditions and clicks on a Submit button. The seller 14 sees that the seller's screen changes and displays a new version of the Negotiating Ticket 34 with the changed terms and price highlighted in yellow, so that the seller 14 can see what is changed. At the same time, the Chat box 32 is available at the bottom of the screen 30, and the parties can chat with one another. At some point in the process of passing the Negotiating Ticket 34 back and forth, assuming one party or the other submits to the other party a firm offer to buy or a firm offer to sell, and the other party clicks on the Accept button 84, the system concludes the transaction. The system gives the concluded transaction a transaction number and sends a confirmation to each party to confirm that the parties have done business with one another for a certain specified product quantity on certain specified price and delivery terms. Additionally, each party can print out a printed version of the contract, which the parties can sign and mail to one another.

In a further aspect of the process of negotiating a transaction according the system and method for an embodiment of the present invention, referring further to FIG. 3, a user can enter into negotiations by clicking on the Respond button 28 of the Quote Recap box 26 in the Quote Board 22, but only in response to a live bid or ask or an inquiry to buy or sell, as opposed to a completed trade or a posting from outside the system. Clicking on the Respond button 28 brings up a complete Negotiating Ticket 34, as shown in FIG. 4, with the fields filled in according to the information contained in the quote selected. Bids and asks are fully filled out, but buys and sells may be incomplete. The user can then accept the quote as-is by clicking the Accept button 84 or change or add information before hitting a Reply button 86 or 88. The Negotiating Ticket 34 has a Communications box 32 embedded in it, in which a message can be sent to the party that initiated the quote either by chat or e-mail, depending on the initiating party's system log-in status and whether a chat invitation has been accepted.

In this aspect of the process of negotiating a transaction, the initiator, such as the party that posted the original quote or, optionally, if he or she is not logged on, someone else in the same company, is notified of the response via chat as a first priority, or via e-mail if unavailable for chat. A chat invitation must be accepted for a chat to begin. If the response was an acceptance of a firm quote by an authorized counterparty for that quote, a completed trade is created and no further negotiation need take place. If the response contained changed terms and/or was not firm, the system message or e-mail sent to the initiating party contains a link that directs that party to the appropriate Negotiation page 30, or if the initiating party is not on the system, to a logon box that leads directly to the Negotiation page 30. In the back and forth negotiations between the two parties involved, either party can accept the firm quote (bid or asked) of the other party. There need not be a final acceptance from the initiator of the firm quote. The initiator is merely notified by system message and email that a transaction has been completed.

The Chat box 32 on the Negotiation page 30 enables two users to carry on a private two-way conversation in the Chat box 32 that appears on the screen with a Negotiating Ticket 34. Each party takes turns making changes to the Negotiating Ticket 34 and the Chat box 32 facilitates negotiating terms. The system keeps track of who last modified the Negotiating Ticket 34. The chat goes on continuously below the Negotiating Ticket 34. Pre-conditions to negotiating a transaction include, for example, that a user is logged in successfully and is an authorized counterparty of the initiator of the quote in order to create a completed trade immediately by accepting it. Otherwise, the user must wait for a response from the initiator to the user's firm reply according to predefined acceptance rules.

For an example of the process of responding to a quote on the system for an embodiment of the present invention when the initiating user is still logged on, utilizing the Chat screen 32, assume that the user that initiated the quote is logged on to the system when another user responds to it by pressing the Respond button 28 on the Quote Recap 26 or the Accept button 84 on the Negotiating Ticket 34 for the quote. The user is prompted with a system message and system e-mail, with links to the Negotiation page 30 containing the Chat box 32 embedded in the Negotiating Ticket 34 displaying the details of the quote in question. A chat invitation must be accepted for a chat to begin.

Continuing with the example of the response when the initiating user is still logged on, if the response is not an acceptance of a firm quote from an authorized counterparty, and thus no completed trade is created, the two users are able to conduct negotiations by passing revised versions of the Negotiating Ticket 34 back and forth while simultaneously carrying on a chat. In this negotiation, each user may in turn alter the terms in the Negotiating Ticket 34 and press the Reply button 86, which locks in the replying member's Negotiating Ticket 34 and refreshes the other member's Negotiating Ticket 34 with the revised terms. This negotiation may continue until a completed trade is created, or until one or both sides tire of trying to come to an agreement over terms. During a negotiation, a user may press a Cancel button to cancel a quote sent in error.

If the initiating party is not available for chat, e-mail notification is used. For an example of the process of responding to a quote on the system for an embodiment of the present invention when the initiating party is not logged on the system, assume that the party that initiated the quote is not logged on to the system or is unavailable for chat when another user responds to the quote by pressing the Respond button 28 on the Quote Recap 26 or the Accept button 84 on the Negotiating Ticket 34 for the quote. The initiator is sent a system message and system and Internet e-mails advising the initiator that his or her quote has been hit. If the response is an acceptance of a firm quote (a bid or an ask) by a party designated as an authorized counterparty for that quote, a completed trade is created by the acceptance, and the initiating party is notified of the acceptance in the system message and e-mails.

If the response to the initial quote does not create a completed trade, the system message and e-mails sent to the party that initiated the quote contains links to the Negotiation page 30 containing a Negotiating Ticket 34 for the particular quote. If the responding party is still logged on to the system, the Negotiation page 30 contains a live Chat box 32, and the initiating party is then able to negotiate and chat with the responding party as described above. If the responding party is not logged on the system or is unavailable for chat, the Negotiation page 30 has an e-mail box instead of Chat box 32 embedded in the Negotiating Ticket 34. The initiating party can alter the terms of the Negotiating Ticket 34 or leave the terms alone before making his or her own response. At any time, if both parties engaged in the negotiation are logged on at the same time and available for chat, they are given the Chat screen 32 when responding to a quote. Upon each generation of a quote, the responding party sets an Expiration time 90 by which the other party must respond. During negotiations, either party can accept a firm quote (a bid or ask that is not a posting) and make it a completed trade, but acceptance can create a completed trade only if the quote does not expire before acceptance.

For accepting and/or responding to a quote, on clicking on a Quote Summary 24 in the Quote Board 22, a Quote-Recap window 26 pops up with the details of the quote and a Respond button 28. Upon pressing the Respond button 28, a full Negotiating Ticket 34 filled in with the information from the quote appears with an Accept button 84 and Reply buttons 86 and 88. A user can accept a firm quote as-is, automatically creating a completed trade, if he or she is an authorized counterparty for the particular quote. Alternatively, the user can reply to the quote by making changes to the Negotiating Ticket 34 and pressing one of the Reply buttons 86 or 88. The reply can be a Firm Reply 86 or in the form of an Inquiry Reply 88. A firm quote is a bid or ask that is not a posting. Inquiry quotes (buy and sell quotes that are not postings) can likewise be accepted or responded to, but acceptance of an inquiry does not automatically create a completed trade, even if the acceptor is an authorized counterparty for the quote. The firm response to an inquiry must be accepted by the initiator to create a completed trade. A trade is not completed until both sides agree to all the terms, which implies a firm quote being made by one side and accepted by the other.

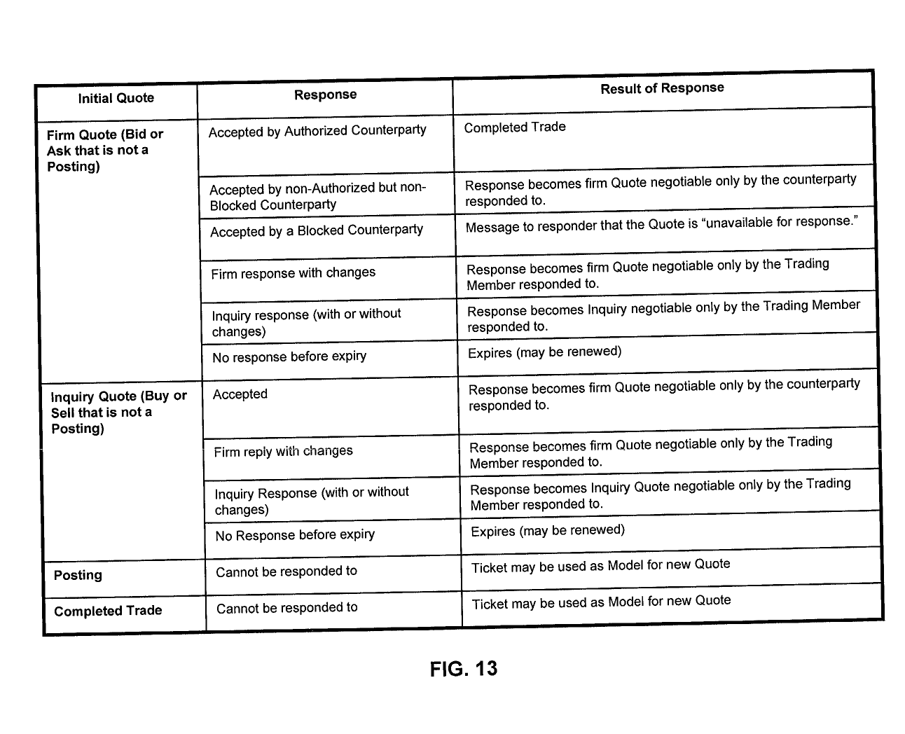

FIG. 13 is a table which illustrates examples of various combinations of quotes and responses that can arise during negotiations in the system and method for an embodiment of the present invention. Referring to FIG. 13, the negotiation process can proceed through several rounds, either with both parties online sending Negotiating Tickets 34 back and forth, or by e-mail, or by a combination of both, until one or both sides tires of attempting to negotiate a deal and does not make a.

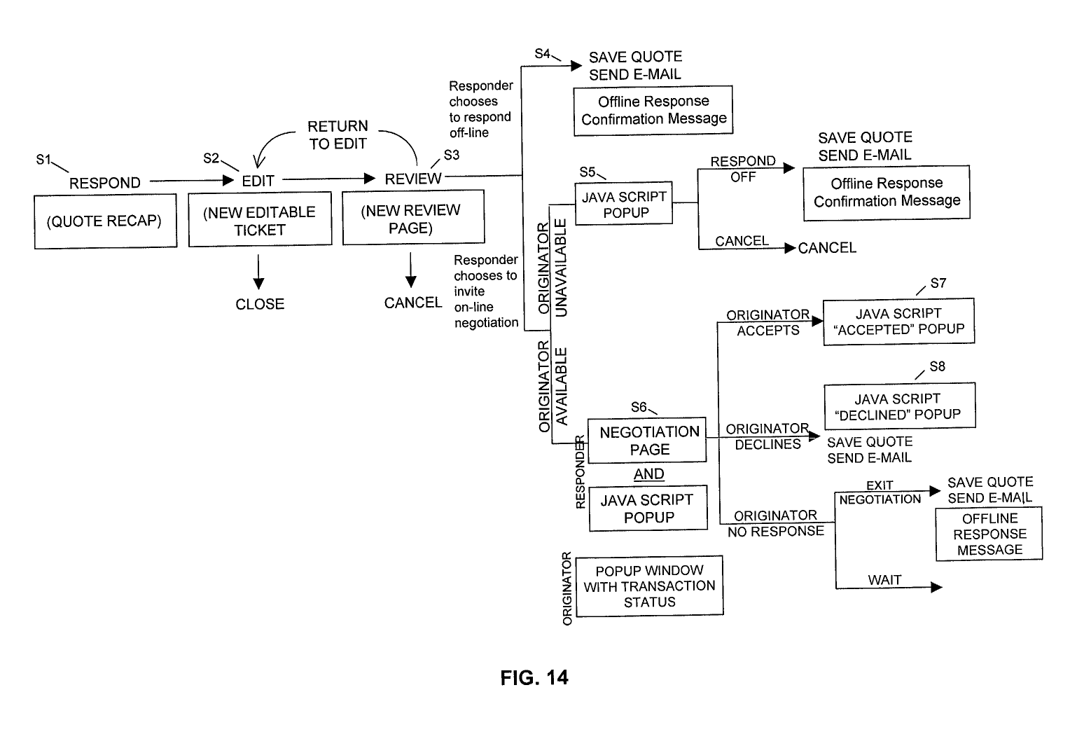

FIG. 14 is a schematic flow chart which illustrates and example of the process of responding to a quote according to the system and method for an embodiment of the present invention. Referring to FIG. 14, at S1, in response to a prompt, the responding party at a PC enters a selection to respond on the Quote Recap window 26 by clicking on the Respond link 28. At S2, a new editable Negotiation Ticket 34 is displayed for the responding party. The responding party is reminded to make any changes to the Negotiation Ticket 34, including Expiration time 90, before replying, prompted to make a selection for an Inquiry or a Firm Response, and invited to enter Continue or Cancel. At S3, the responding party is presented with an Online Review/Confirm page and prompted to select one of Submit and Notify by Email, Submit and Send Invitation to Live Negotiation, Cancel and Return to Editing this Ticket, and Cancel Response. If the responding party chooses Submit and Notify by Email, at S4, the responding party is presented with an Offline Response Confirmation, such as, “You have responded to <Firm Name> with a “FIRM/INQUIRY> <BUY/SELL> Quote ID: <nnn>. Your response will appear on a Response Page of that firm. An e-mail notification of your response has also been sent.”

Referring further to FIG. 14, if the responding party chooses Submit and Send Invitation to Live Negotiation, and if the other party is not online, at S5, the responding party is presented a message, such as, “The party you are responding to is not online. Click ‘OK’ to respond anyway and send an e-mail notification of your response. Click ‘Cancel’ to cancel your response.” Otherwise, at S6, the originating party is presented an existing Negotiation page with selections for Firm Reply, Inquiry Reply, View History, and End Live Negotiation and text messages, such as, “Before Replying, make your changes, including Expiration time, to this ticket” and “This ticket shows your latest Reply.” In addition, at S6, the responding party is presented a Confirmation of Online Negotiation Invitation, such as, “Your have sent an invitation to negotiate live and establish an online chat session. The party you invited may accept or decline it, or may be away from their computer. You can wait for a response or click on ‘End chat Negotiation’ to exit the negotiation screen and send an e-mail notification of your response. Either way, your response will always appear on a Response Page of the firm you are responding to.” Further, at S6, the originating party is presented an Invitation to Negotiate via Live Chat, such as, “<user first name, user last name> of <full firm name> has responded to your Quote with <inquiry/firm> <buy/sell> Quote#<nnn>,” and invited to select either a button for <Negotiate Live> or <Decline Invitation> with a textual message, such as “Your have been invited to negotiate this Quote live and establish an online chat session. You may accept the invitation, or decline and view the response under Physicals>My Physicals>Active Quotes or Expired Quotes, by clicking on the link in the “R” column. If your decline, you will receive e-mail notification of the response.”

Referring further to FIG. 14, if the originating party accepts the invitation to negotiate live, at S7, the responding party is presented with a Confirmation of Accepted Invitation to Live Chat Negotiation message, such as, “Your invitation to negotiate live has been accepted. Please wait for your counterparty's name to appear in the ‘Members Currently in this Chat Room’ window before sending any text messages.” If the originating party declines the invitation to negotiate live, at S8, the originating party is presented with a Confirmation of Declined Negotiation Invitation message, such as, “A message declining to negotiate live has been sent to <user first name, user last name> of <firm name>. To view that party's Response to your Quote#<nnn>, go to: Physicals>My Physicals>Active Quotes or Expired Quotes and click on the ‘R’ column of that Quote.” In addition, if the originating party declines the invitation to negotiate live, also at S8, the responding party is presented an Advice of Declined Negotiation Invitation message, such as, “Your invitation to negotiate has been declined. Your response will appear on a Response Page of the firm you are responding to and an e-mail notification of your response will be sent.”

An important aspect of the system and method of an embodiment of the present invention involves the concepts of Counterparties and Posting Levels. Counterparties are those other firms with which a particular firm is willing to do business. The other firms which a particular firm finds acceptable as Counterparties depends on a number of factors including, for example, credit rating, reliability, selection of product offerings (in the case of a supplier), selection of buying needs (in the case of a customer), quality of goods supplied, and the desire to distribute business among several competing firms. The system accommodates the fact that the Counterparties which a particular firm finds acceptable often varies from transaction to transaction, depending on the nature of the transaction and factors, such as the foregoing factors. The visibility of a given bid, offer or expression of buying or selling interest is also of critical importance to firms seeking to transact business within the system. The system allows a user to control the visibility of the user's business transactions on a transaction-by-transaction basis. This ranges from conducting one-on-one negotiations in total privacy, to broadcasting the negotiations to all the other registered users of the system. The system uses a combination of a Counterparty List and a Posting Level for each quote to accomplish this control.

The system for an embodiment of the present invention manages Counterparties, for example, on three levels including, for example, a Firm Master Counterparty List, Personal Counterparty Lists, and a Quote Counterparty List. The Firm Master Counterparty List is chosen by an authorized administrator(s) for a given firm from among the complete set of users registered on the system. The Personal Counterparty Lists are created for convenience by individual users for a firm from among the Counterparties on the firm's Firm Master Counterparty List. The Quote Counterparty List is determined by a user immediately before submitting a quote. The Quote Counterparty List can consist, for example, of a previously created Personal Counterparty List (either complete or edited on the spot); or it can be manually selected from the Firm Master Counterparty List of the firm. Counterparties are controlled on a quote-by-quote basis. The Quote Counterparty List is used in determining, for example, who can accept a firm quote as-is without further confirmation from the originator of the quote. The Quote Counterparty List is also used in combination with the Quote Posting Level to control the visibility of the quote to other users on the system. The Quote Counterparty List and Posting Level functionalities are available both in submitting a fresh quote to the system and when responding to a quote originated by another user.

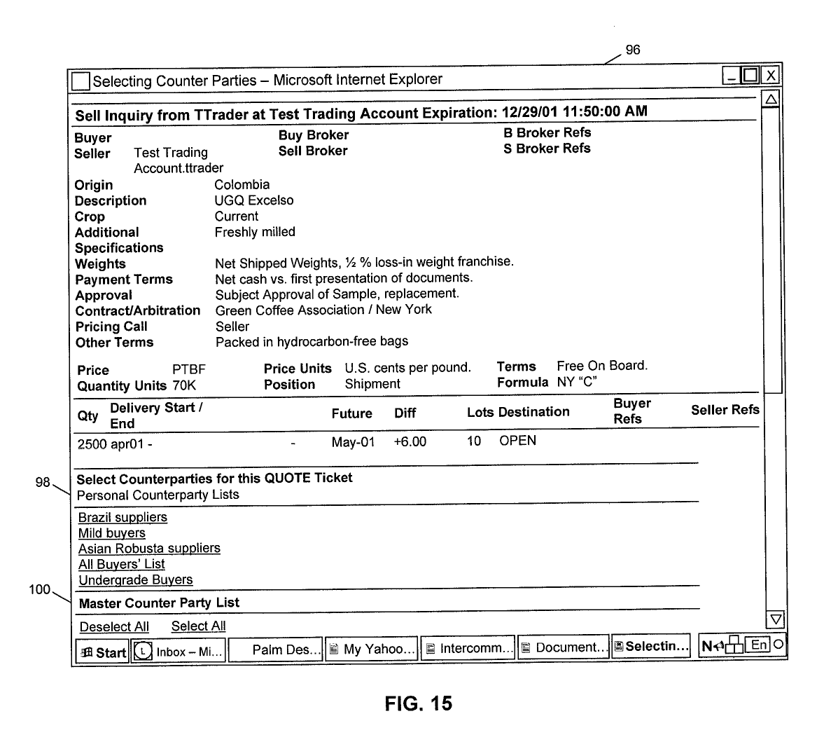

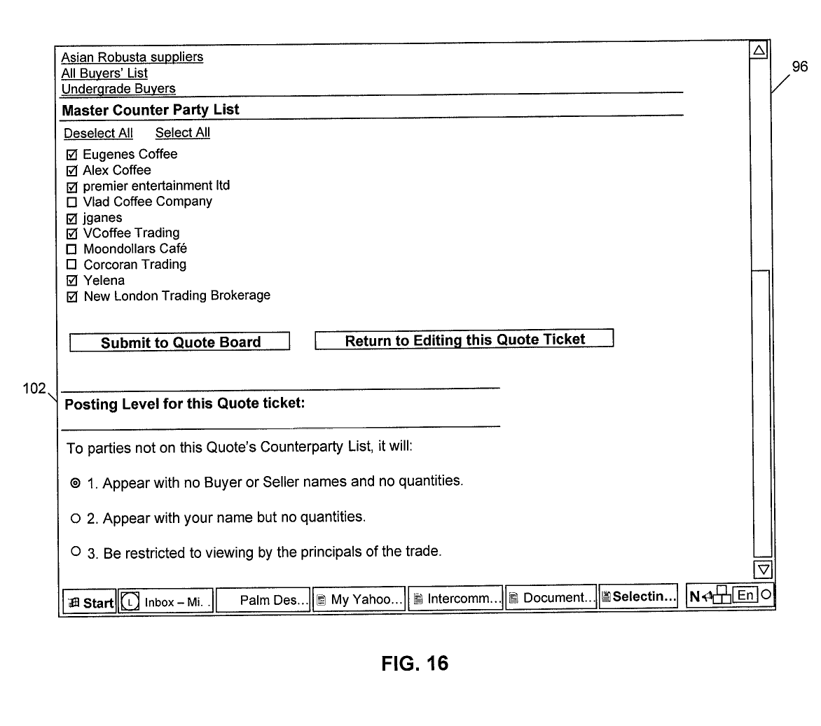

FIGS. 15, 16 and 17 show a sample Quote Review GUI page for an embodiment of the present invention as it appears in submitting an original quote. However, it is noted that a Quote Review page for response to an existing quote is substantially similar. Referring to FIG. 15, a principal feature of an upper part of the Quote Review page 96 includes, for example, a list of Personal Counterparty Lists 98 (sub-lists of the submitting firm's Firm Master Counterparty List). By clicking on a particular Personal Counterparty List, the Counterparties on that Personal Counterparty List are automatically selected from the Firm Master Counterparty List 100. The submitter can then further modify the Counterparty to meet the submitter's requirements for the particular quote. Referring to FIG. 16, a lower part of the Quote Review page 96 for an original submission of an inquiry quote shows Counterparties actually selected for the particular quote and the Posting Level (or visibility to third parties) selection panel 102 that determines the visibility on the system for the particular quote. Note that since this is an inquiry rather than a firm quote, only one Posting Level panel 102 appears. There is no contingent Posting Level in case the quote results in a trade, since an Inquiry Quote cannot be accepted as-is by a responding party.

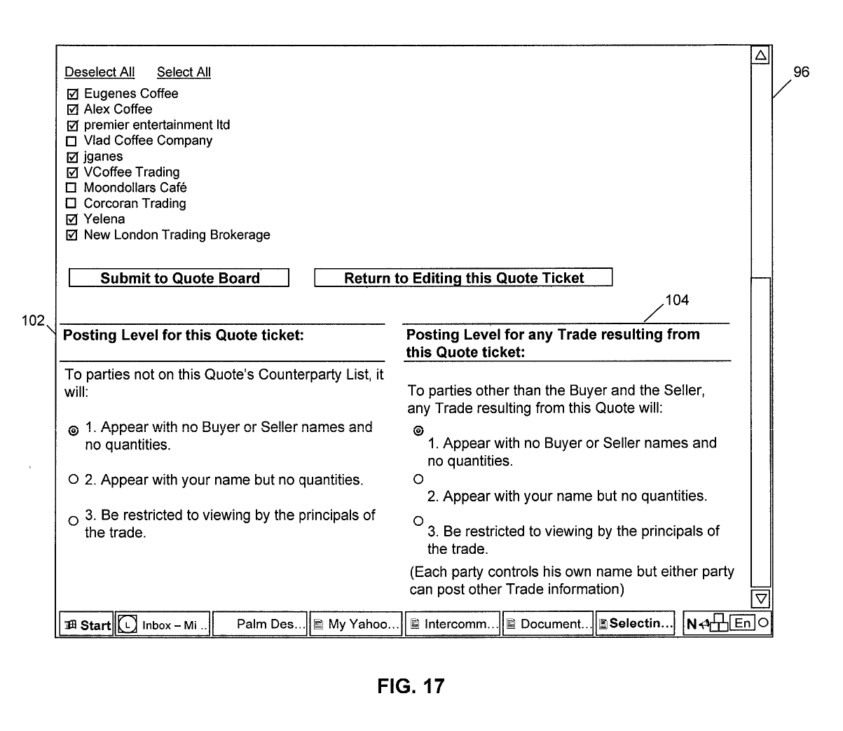

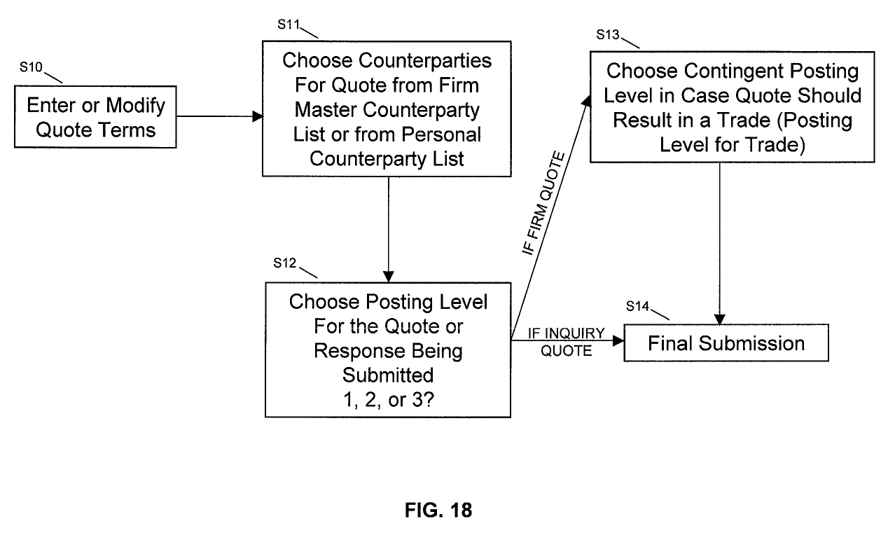

Referring to FIG. 17, a bottom part of the Quote Review page 96 for an original submission of a firm quote shows Counterparties actually selected for the particular quote and two Posting Level (or visibility to third parties) selection panels 102 and 104 that determine the visibility on the system for this particular quote and for any trade that may result from this quote. Since the quote is firm, there is a second, contingent Posting Level 104 in case the quote results in a trade upon being accepted as-is by a responder. FIG. 18 is a schematic flow chart which illustrates an example of the process of Posting Level selection for an embodiment of the present invention. Referring to FIG. 18, the sample Posting Level selection process applies to both entering an original quote and responding to an existing quote. At S10, in response to prompts, the user at a PC enters or modifies the terms of a quote. At S11, in response to further prompts, the user at the PC enters the user's selection of Counterparties from a Firm Master Counterparty List 100 or a Personal Counterparty List 98 displayed on the Quote Review page 96. At S12, in response to additional prompts, the user at the PC enters a selection of a Posting Level for the quote or response being submitted, such that to parties not on the Counterparty List for the particular quote, the quote either will appear with no buyer or seller names or quantities (known as “Posting Level 1”), or will appear with the submitter's name but no quantities (known as “Posting Level 2”), or will be restricted to viewing by the principles of the trade (known as “Posting Level 3”). If the quote is a firm quote, at S13, in response to prompts, the user enters a contingent Posting Level from one of Posting Levels 1, 2, or 3, in case the quote results in a trade. At S14, in response to prompts, the user submits the quote.

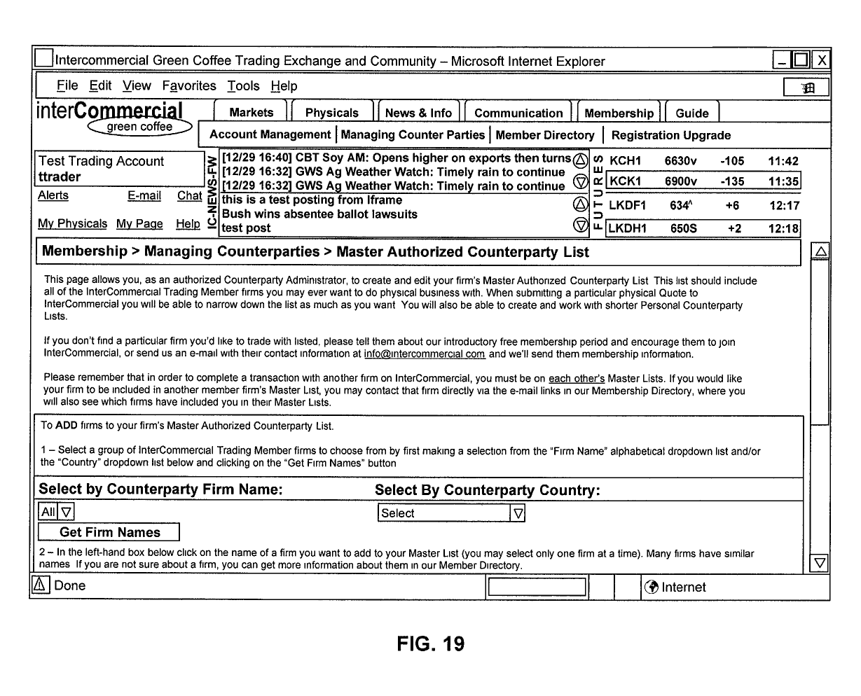

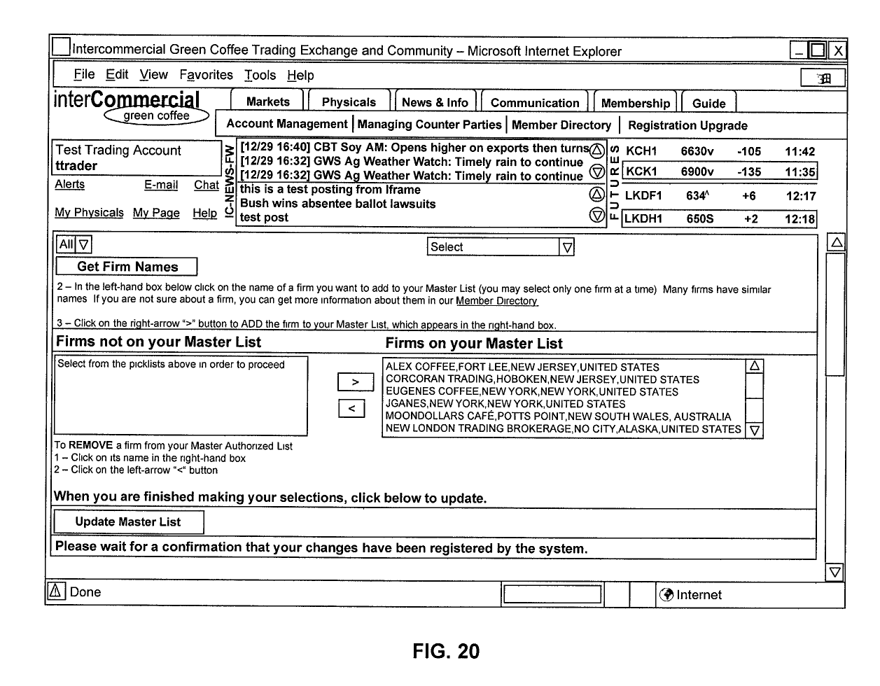

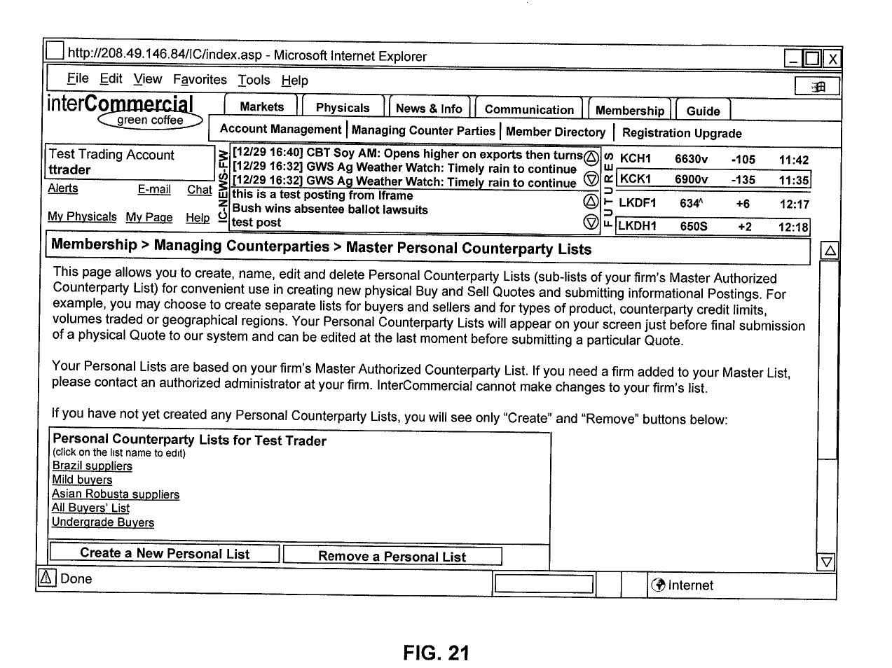

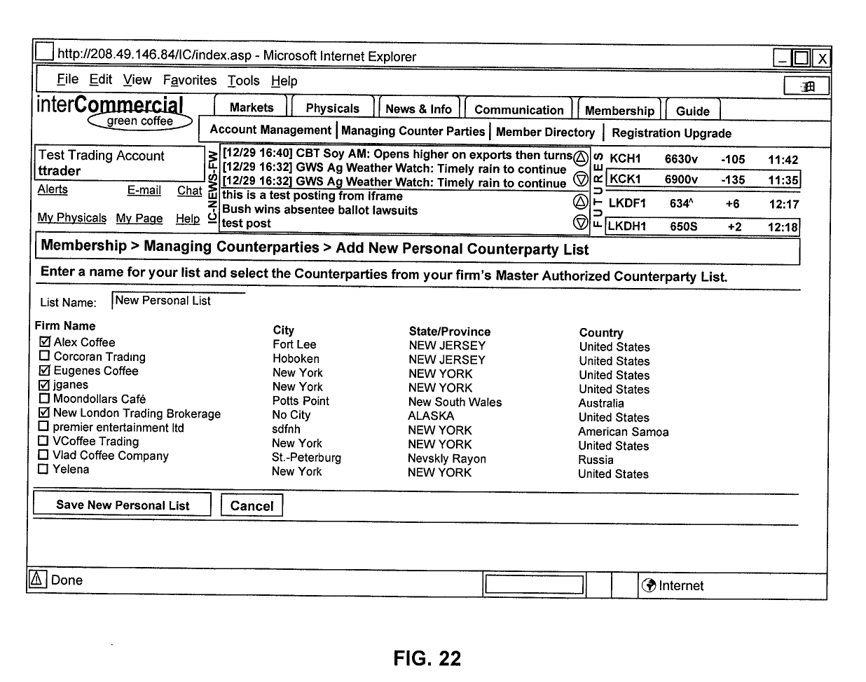

FIGS. 19 and 20 show a sample GUI screen for selection of a firm's Firm Master Counterparty List for an embodiment of the present invention. FIG. 21 shows a sample Main Managing Personal Counterparty Lists GUI page for an embodiment of the present invention. FIG. 22 shows a sample Add (Create) New Personal Counterparty List page for an embodiment of the present invention.

Various preferred embodiments of the present invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for negotiating a transaction over a network, comprising:
receiving information relative to a quote for a proposed transaction from a first user;
allowing a second user to access the information relative to the quote for the proposed transaction;
receiving information from the second user relative to a response to the quote for the proposed transaction;
presenting the information relative to the response to the first user according to a preferred presentation method of the second user;
receiving information from the first user relative to a reply to the response of the second user; and
confirming a contract between the first and second users relative to the proposed transaction, if the first and second users agree on information relative to the proposed transaction.

2. The method of claim 1, wherein receiving the information relative to the quote further comprises receiving the information from the first user at a first user terminal.

3. The method of claim 2, wherein receiving the information relative to the quote further comprises receiving the information at the first user terminal coupled to a server over a global network.

4. The method of claim 2, wherein receiving the information relative to the quote further comprises displaying a quote entry area for the first user on a display screen of the first user terminal.

5. The method of claim 4, wherein receiving the information relative to the quote further comprises allowing the first user to enter the information on the quote entry area of the display screen.

6. The method of claim 5, wherein receiving the information relative to the quote further comprises allowing the first user to enter the information on one of a blank negotiation ticket and a pre-formatted negotiation ticket in the quote entry area of the display screen.

7. The method of claim 1, wherein receiving the information relative to the quote further comprises receiving the information consisting of at least one of a subject matter description for the proposed transaction, a quantity for the proposed transaction, a payment term for the proposed transaction, a delivery term for the proposed transaction, and a price term for the proposed transaction.

8. The method of claim 7, wherein receiving the information relative to the quote further comprises receiving the information relative to one of a firm quote and an inquiry quote relative to the proposed transaction.

9. The method of claim 8, wherein receiving the information relative to the firm quote further comprises receiving the information relative to the firm quote for the proposed transaction which can be accepted by a pre-approved counterparty.

10. The method of claim 8, wherein receiving the information relative to the inquiry quote further comprises receiving the information relative to the inquiry quote which only demonstrates an interest of the first user in the proposed transaction.

11. The method of claim 1, wherein allowing the second user to access the information relative to the quote further comprises pre-defining parameters by the first user for the second user for access to the information relative to the quote on a quote-by-quote basis.

12. The method of claim 11, wherein pre-defining the parameters further comprises pre-defining the parameters by the first user to include the second user on a list of counterparties pre-approved for the proposed transaction.

13. The method of claim 11, wherein pre-defining the parameters further comprises pre-defining the parameters by the first user to permit visibility of the information relative to the quote to the second user, while controlling the level of visibility of the information relative to the quote to counterparties not pre-approved for a specific proposed transaction via posting levels.

14. The method of claim 1, wherein allowing the second user to access the information relative to the quote further comprises allowing the second user to access the information at a second user terminal.

15. The method of claim 14, wherein allowing the second user to access the information relative to the quote further comprises allowing the second user to access the information at the second user terminal coupled to a server over a global network.

16. The method of claim 14, wherein allowing the second user to access the information relative to the quote further comprises displaying a summary of the information relative to the quote for the second user in a quote summary area of a quote board on a display screen of the second user terminal.

17. The method of claim 16, wherein allowing the second user to access the information relative to the quote further comprises displaying details of the information relative to the quote for the second user in a quote recap area of the quote board.

18. The method of claim 1, wherein receiving the information relative to the response further comprises receiving the information relative to the response from the second user at a second user terminal.

19. The method of claim 18, wherein receiving the information relative to the response further comprises receiving the information for the response at the second user terminal coupled over a global network to a server.

20. The method of claim 18, wherein receiving the information relative to the response further comprises allowing the second user to enter the information on an amendable negotiation ticket filled out with the information relative to the quote displayed on a display screen of the second user terminal.

21. The method of claim 20, wherein allowing the second user to enter the information relative to the response further comprises allowing the second user to enter the information on the amendable negotiation ticket filled out with the information relative to the quote consisting of at least one of a subject matter description for the proposed transaction, a quantity for the proposed transaction, a payment term for the proposed transaction, a delivery term for the proposed transaction, and a price for the proposed transaction.

22. The method of claim 20, wherein allowing the second user to enter the information relative to the response further comprises displaying the amendable negotiation ticket in response to a selection by the second user of a respond option on a quote recap window on the display screen of the second user terminal.

23. The method of claim 20, wherein allowing the second user to enter the information relative to the response further comprises allowing the second user to enter the information relative to the response consisting of at least one amendment to the filled out information relative to the quote on the amendable negotiation ticket.

24. The method of claim 18, wherein receiving the information relative to the response further comprises allowing the second user to designate the information as information relative to one of a firm response to the quote, which becomes a firm quote negotiable only by the first user, and an inquiry response to the quote, which becomes an inquiry quote negotiable only by the first user.

25. The method of claim 1, wherein presenting the information relative to the response further comprises presenting the information relative to the response to the first user at a first user terminal.

26. The method of claim 25, wherein presenting the information relative to the response further comprises presenting the information relative to the response to the first user at the first user terminal coupled to a server over a global network.

27. The method of claim 1, wherein presenting the information relative to the response further comprises receiving a selection by the second user of the preferred presentation method for the information relative to the response.

28. The method of claim 27, wherein presenting the information relative to the response according to the preferred presentation method further comprises presenting the information to the first user by email.

29. The method of claim 28, wherein presenting the information relative to the response to the first user by email further comprises presenting the information on a response page for the first user and sending an email notification of the information to the first user.

30. The method of claim 1, wherein presenting the information relative to the response according to the preferred presentation method further comprises presenting the information in connection with an invitation to the first user for a live negotiation.

31. The method of claim 30, wherein presenting the information relative to the response in connection with the invitation for the live negotiation further comprises notifying the second user if the first user is unavailable online.

32. The method of claim 31, wherein presenting the information relative to the response in connection with the invitation for the live negotiation receiving a selection of the second user of one of an option of presenting the information on a response page for the first user and sending an email notification to the first user and an option of canceling the response of the second user if the first user is unavailable online.

33. The method of claim 30, wherein presenting the information relative to the response in connection with the invitation for the live negotiation further comprises presenting the first user an amendable negotiation ticket if the first user is available online.

34. The method of claim 33, wherein presenting the information relative to the response in connection with the invitation for the live negotiation further comprises allowing the second user to enter at least one amendment on the amendable negotiation ticket if the first user is available online.

35. The method of claim 34, wherein presenting the information relative to the response in connection with the invitation for the live negotiation further comprises receiving a selection of the second user of one of an option of presenting the information as a firm response and presenting the information relative to the response as an inquiry response if the first user is available online

36. The method of claim 1, wherein receiving the information relative to the reply to the response further comprises prompting the first user to view the information relative to the response.

37. The method of claim 1, wherein receiving the information relative to the reply to the response further comprises receiving the information relative to the reply from the first user at a first user terminal.

38. The method of claim 37, wherein receiving the information relative to the reply to the response further comprises receiving the information relative to the reply to response at the first user terminal coupled to a server over a global network.

39. The method of claim 1, wherein receiving the information relative to the reply to the response further comprises sending a notification to the second user if the first user declines an invitation from the second user for a live negotiation with the second user.

40. The method of claim 39, wherein receiving the information relative to the reply the response further comprises sending a confirmation to the first user if the first user declines the invitation.

41. The method of claim 39, wherein receiving the information relative to the reply to the response further comprises sending a notice to the second user that the information relative to the response will appear on a response page of the first user if the first user declines the invitation.

42. The method of claim 1, wherein receiving the information relative to the reply to the response further comprises sending a notice to the first user that the information relative to the quote has been accessed if the first user is available online.

43. The method of claim 42, wherein receiving the information relative to the reply to the response further comprises querying the first user regarding a willingness to negotiate directly online with the second user if the first user is available online.

44. The method of claim 43, wherein receiving the information relative to the reply to the response further comprises displaying a message for the first user inviting the first user to engage in an on-line chat session with the second user while reviewing an amendable negotiation ticket if the first user is available online.

45. The method of claim 44, wherein receiving the information relative to the reply to the response further comprises displaying an amendable negotiation ticket for the first user consisting of a modifiable and electronically transmittable trading ticket integrated with an internet relay chat box enabling the first and second users to communicate and pass the ticket back and forth.

46. The method of claim 1, wherein confirming a contract between the first and second users relative to the proposed transaction further comprises allowing the first and second users to communicate with one another and pass a modifiable and electronically transmittable negotiation ticket integrated with an internet relay chat box back and forth.

47. The method of claim 46, wherein confirming the contract between the first and second users relative to the proposed transaction further comprises receiving information relative to a firm offer from one of the first and second users.

48. The method of claim 47, wherein confirming the contract between the first and second users relative to the proposed transaction further comprises receiving an acceptance of the firm offer by the other of the first and second.

49. The method of claim 48, wherein confirming the contract between the first and second users relative to the proposed transaction further comprises assigning a transaction number to the confirmed contract.

50. The method of claim 49, wherein confirming the contract between the first and second users relative to the proposed transaction further comprises sending a notice of the confirmation to each of the first and second users.

51. The method of claim 50, wherein confirming the contract between the first and second users relative to the proposed transaction further comprises allowing at least one of the first user and the second user to print out at a hard copy of the confirmed contract.

52. A system for negotiating a transaction over a network, comprising:
means for receiving information relative to a quote for a proposed transaction from a first user;
means for allowing a second user to access the information relative to the quote for the proposed transaction;
means for receiving information from the second user relative to a response to the quote for the proposed transaction;
means for presenting the information relative to the response to the first user according to a preferred presentation method of the second user;
means for receiving information from the first user relative to a reply to the response of the second user; and
means for confirming a contract between the first and second users relative to the proposed transaction, if the first and second users agree on information relative to the proposed transaction.

53. The system of claim 52, wherein the means for receiving the information relative to the quote further comprises a first user terminal.

54. The system of claim 53, wherein the first user terminal further comprises a first user computer terminal coupled to a server over a network.

55. The system of claim 54, wherein the network further comprises a global network.

56. The system of claim 52, wherein the means for allowing the second user to access the information relative to the quote further comprises a second user terminal.

57. The system of claim 56, wherein the second user terminal further comprises a second user computer terminal coupled to a server over a network.

58. The system of claim 57, wherein the network further comprises a global network.

59. The system of claim 52, wherein the means for receiving the information relative to the response further comprises a second user terminal.

60. The system of claim 58, wherein the second user terminal further comprises a second user computer terminal coupled to a server over a network.

61. The system of claim 60, wherein the network further comprises a global network.

62. The system of claim 52, wherein the means for presenting the information relative to the response further comprises a first user terminal.

63. The system of claim 62, wherein the first user terminal further comprises a first user computer terminal coupled to a server over a network.

64. The system of claim 63, wherein the network further comprises a global network.

65. The system of claim 52, wherein the means for receiving the information relative to the reply to the response further comprises a first user terminal.

66. The system of claim 65, wherein the first user terminal further comprises a first user computer terminal coupled to a server over a network.

67. The system of claim 66, wherein the network further comprises a global network.

68. The system of claim 52, wherein the means for confirming the contract between the first and second users relative to the proposed transaction further comprises a first and a second user terminal coupled to a server over a network.

69. The system of claim 68, wherein the network further comprises a global network.
